(19) United States
(12) Patent Application Publication
(10) Pub. No.: US 2005/0246217 A1
(43) Pub. Date: Nov. 3, 2005

(54) System and methods of mobile field inspection

(76) Inventor: Mark W. Horn, Macon, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/978,502

(22) Filed: Nov. 1, 2004

Related U.S. Application Data
(60) Provisional application No. 60/567,424, filed on Apr. 30, 2004.

(51) Int. Cl. G06F 7/00

(52) U.S. Cl. 705/9; 235/376

(57) ABSTRACT

The present invention comprises a system and methods for managing janitorial, security, lighting, and temporary labor services provided to commercial, industrial, institutional, and retail facilities. The present invention comprises a system and methods for managing facility services though a mobile field inspection system. The mobile field inspection system provides a wireless network that enables a facility manager to supervise the performance of services by other employees at a particular facility. The present invention further comprises a system and methods for performing a series of quality inspections of a facility to ensure that services are performed satisfactorily. Additionally, the present invention provides a constant, proactive communication between the facilities contractor/manager and the customer purchasing the services. Further, the present system comprises a system and methods for performing services and inspections using systematically positioned barcodes for efficient tracking and reporting purposes.

### CROSS-REFERENCE TO RELATED APPLICATIONS

This application claims priority to U.S. Provisional Patent Application Ser. No. 60/567,424, filed on Apr. 30, 2004.

### FIELD OF THE INVENTION

The present invention relates generally to a system and methods of mobile field inspection and, more specifically, to a system and methods of mobile field inspection for janitorial services.

### BACKGROUND OF THE INVENTION

Fundamental to any organization's success is the often tedious task of maintaining the facility in which business is conducted. Larger or more complex organizations require a more structured and effective maintenance program, because, although ancillary, janitorial, security, lighting, and temporary labor services are critical in the pursuit of an organization's main objectives. Providing effective and efficient facility services may include a successful work schedule encompassing the type of services to be completed, the time in which the services must be performed, the types of materials and resources necessary to perform the services, the employees involved in performing services, and the priority of the services to be provided. Traditionally, such scheduling was performed manually and, therefore, was slow and prone to human error. Additionally, effective management of services provided at a particular facility requires systematic inspections designed to discover deficiencies within such provided services.

Although several computer and software products exist to address the scheduling of services and the inspection of facilities, few are suitable for organizations with complicated facility service needs such as school systems, large businesses, or organizations with multiple facilities. Of the products that do exist, none provide a systematic approach to providing services and inspecting facilities that ensures seamless resolution of deficiencies, while maintaining an open communication between the field services company and the organization (e.g., customer).

Accordingly, there is a need in the industry for a system and methods for managing a mobile field inspection system and providing effective facility services, while sustaining a systematic and seamless system for ensuring quality performance of services and a follow-up mechanism to ensure that any and all deficiencies have been address appropriately.

### SUMMARY OF THE INVENTION

Broadly described, the present invention comprises a system and methods for managing janitorial, security, lighting, and temporary labor services provided to commercial, industrial, institutional, and retail facilities. More particularly, the present invention comprises a system and methods for managing facility services though a mobile field inspection system. The mobile field inspection system provides a wireless network that enables a facility manager to supervise the performance of services by other employees at a particular facility. The present invention further comprises a system and methods for performing a series of quality inspections of a facility to ensure that services are performed satisfactorily. Additionally, the present invention provides a constant, proactive communication between the facilities contractor/manager and the customer purchasing the services. Further, the present system comprises a system and methods for performing services and inspections using systematically positioned barcodes for efficient tracking and reporting purposes.

In an exemplary embodiment of the present invention, the present invention is implemented by a mobile field inspection system including a computer server system that is accessible, via a communication network, by communication devices of appropriately authorized employees of the facility services company. The computer server system is configured with computer software program and/or modules that, when executed by a processing unit of the computer server system: provide cleaning programs describing the types of services to perform at a facility on a particular day; provide inspections to be conducted at the facility to ensure that services are being performed effectively; receive service data and inspection data compiled by employees of the facility services company via various communication devices connected to a communication network; determine whether deficiencies exist within currently provided services; create work orders to remedy (e.g., resolve) any discovered deficiencies within the currently provided services; provide work orders to particular employees of the facility services company for completion; schedule services and inspections at a particular facility; create reports of inspection and service data to be used to improve the overall performance of the services rendered by the facility services company; and provide user interfaces for the users of the computer server system to the transaction of data to and from the computer server system. Importantly, the computer software programs and/or modules, when executed by a processing unit of the computer server system also store information related to the services and inspections in a database and make such information accessible to and reviewable by the customer or employees of the facility services company on an authorization level basis, wherein access to such information is controlled by respective access levels.

In another exemplary embodiment of the present invention, the present invention is implemented by and includes a business method which streamlines the performance of services and inspections of a facility, while ensuring open communication between the facility services company and the customer. According to such method, the computer server system is accessed by an employee of the facility services company to designate a set of specifications corresponding to a particular facility. The set of specifications, generally, may include a list of tasks to be performed at the facility and the frequency at which the tasks will be performed. Using wireless communication devices that communicate with the computer server system, employees of the facility services company perform a series of inspections that collect data as to whether the services performed at the facility are to a satisfactory level. Employees communicate any deficiencies discovered in the inspections to the computer server system, which generates a correspondence to the customer noting the deficiencies. The computer server system then may provide work orders to employees of the facility services company to address the deficiencies found in the inspections. After the deficiencies have been resolved, the computer server system generates a second correspondence to the customer noting the resolution of the deficiencies.

Other features and advantages of the present invention will become apparent upon reading and understanding the present specification when taken in conjunction with the appended drawings.

### BRIEF DESCRIPTION OF THE DRAWINGS

FIG. 1 displays a block diagram representation of a communications network environment in accordance with an exemplary embodiment of the present invention.

FIG. 2 displays a block diagram representation of an exemplary computing environment in which the present invention may be implemented.

FIG. 3 displays a flowchart representation of a method of quality management for janitorial services in accordance with an exemplary embodiment of the present invention.

FIG. 4 displays a flowchart representation of a method of managing inspections for janitorial services in accordance with an exemplary embodiment of the present invention.

FIG. 5 displays a flowchart representation of a method of creating an inspection order in accordance with an exemplary embodiment of the present invention.

FIG. 6 displays a flowchart representation of a method of scheduling an inspection in accordance with an exemplary embodiment of the present invention.

FIG. 7 displays a flowchart representation of a method of dispatching an inspection order in accordance with an exemplary embodiment of the present invention.

FIG. 8 displays a flowchart representation of a method of performing an inspection in accordance with an exemplary embodiment of the present invention.

FIG. 9 displays a flowchart representation of a method of creating a work request in accordance with an exemplary embodiment of the present invention.

FIG. 10 displays a flowchart representation of a method of performing a follow-up inspection in accordance with an exemplary embodiment of the present invention.

FIG. 11 displays a flowchart representation of a method of creating and viewing inspection reports in accordance with an exemplary embodiment of the present invention.

FIG. 12 displays a diagram representation of a dispatch interface to an online field inspection system in accordance with an exemplary embodiment of the present invention.

### DETAILED DESCRIPTION OF THE DRAWINGS

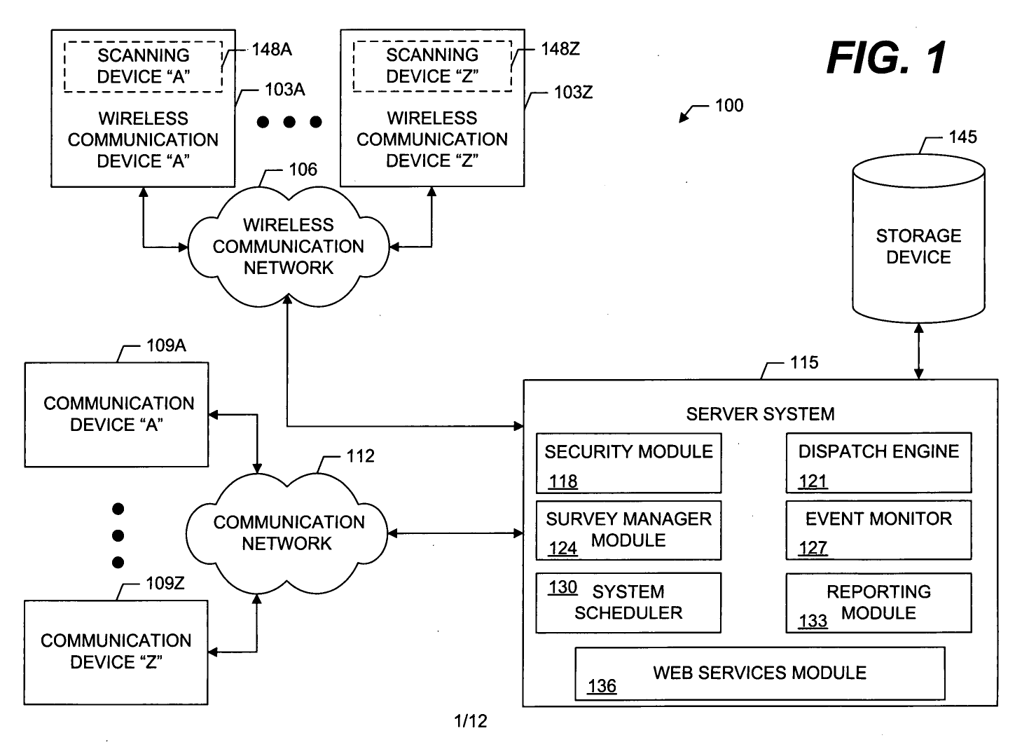

Referring now to the drawings, in which like numerals refer to like parts throughout the several views, FIG. 1 displays a block diagram representation of a communications network environment 100 in accordance with an exemplary embodiment of the present invention. Generally, the present invention provides a mobile field inspection system accessible remotely by multiple users (e.g., customers, inspectors, employees, facility services contractors, and facilities/site managers). The mobile field inspection system enables a facility services contractor to effectively manage service quality through the use of, for example and not limitation, wireless (e.g., handheld) technology, electronic mail (e-mail), and web-based software modules. Additionally, the mobile field inspection system permits a facility services contractor to effectively and efficiently conduct inspections of a facility to ensure that services have been performed and to note any deficiencies. To facilitate remote access by multiple users, the present invention may include a communications network environment 100 comprising a plurality of wireless communication devices 103, a wireless communication network 106, a plurality of communication devices 109 (e.g., for wired communication), a communication network 112, and a server system 115.

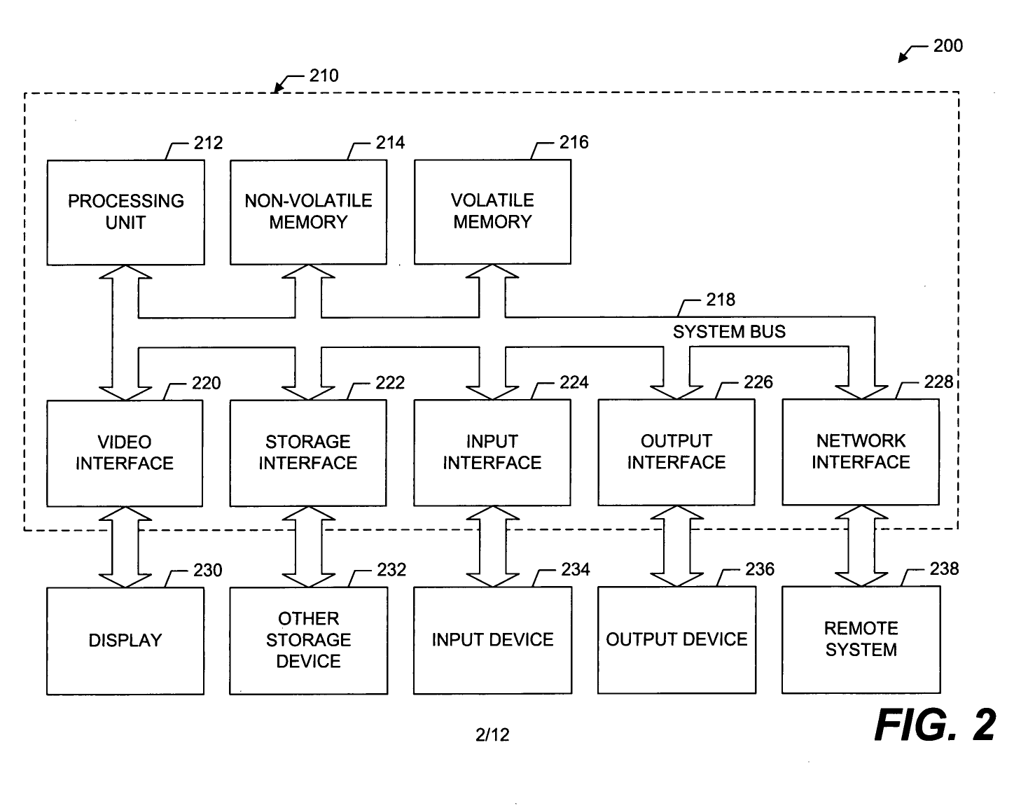

Wireless communication devices 103 may include, but are not limited to, a laptop computer, mobile computer, wireless phone, personal digital assistant (PDA), and any other mobile device capable of communicating over a network. In an exemplary embodiment of the present invention, the wireless communication devices 103 are similar to the computer system 210 described more fully below with reference to FIG. 2. Each wireless communication device 103 connects communicatively to a wireless communication network 106, through the use of the wireless communication device's 103 network interface card and other appropriate hardware and software components, for the bi-directional communication of data therewith. The number of wireless communication devices 103 may vary depending on the number of users accessing the mobile field inspection system and, therefore, the communications network environment 100 is not limited to the two wireless communication devices 103A, Z shown in FIG. 1.

Additionally, each wireless communication device 103 may comprise a scanning device 148 capable of capturing data from, for example, a barcode or other identification mechanism. Scanning devices 148 may include, but are not limited to, handheld scanners, wand scanners, universal serial bus (USB) scanners, PS/2 keyboard wedge scanners, serial (RS232) scanners, cordless scanners, wireless radio-frequency (RF) scanners, wireless fidelity (Wi-Fi) scanners, laser scanners, raster scanners, charge coupled device (CCD) scanners, imager scanners, and any other convenient existing or later developed scanning technology.

One skilled in the art will recognize that wireless communication devices 103 generally provide an operating system and/or user interface to enable users to perform certain tasks and communicate over a wireless communication network 106. The user interface (not shown) may be designed in a variety of embodiments and formats that range from a simple to more complex configuration. In an exemplary embodiment of the present invention, the user interface may comprise keypad, display, touch screen or other convenient device, and may also comprise program modules or machine instructions that perform the tasks described herein, which instructions may be executed on a processing unit 212. For example, the user interface may be a touch screen having a graphical user interface (GUI) adapted to provide data and receive input by the touching of the screen.

The wireless communication devices 103 communicatively connect to a wireless communication network 106. One skilled in the art will recognize that a wireless communication network 106 typically comprises the infrastructure and facilities appropriate to communicatively connect a group of two or more wireless communication devices 103 (including, without limitation, a plurality of computer systems in communication with each other). Such a wireless communication network 106 and wireless communication devices 103 may be configured in multiple topologies including, but not limited to, star, bus, or ring configurations. Also, a wireless communication network 106 and wireless communication devices 103 may be broadly categorized as belonging to a particular architecture including, but not limited to, peer-to-peer or client/server architectures. The wireless communication network 106 may additionally be classified by the geographical location of the wireless communication devices 103 and the types thereof. For example, a wireless communication network 106 communicatively connecting a plurality of computer systems or servers located proximate to each other, such as within a building, is referred to as a local-area network (LAN); if the computer systems are located farther apart, the wireless communication network 106 is generally referred to as a wide-area network (WAN), such as the Internet; if the computer systems are located within a limited geographical area, such as a university campus or military establishment, the wireless communication network 106 is referred to as a campus-area network (CAN); if the computer systems are connected together within a city or town, the wireless communication network 106 is referred to as a metropolitan-area network (MAN); and if the computer systems are connected together within a user's home, the wireless communication network 106 is referred to as a home-area network (HAN).

Communication devices 109 (e.g., wired communication devices) may include, but are not limited to, a desktop computer, laptop computer, server computer, personal digital assistant (PDA), and any other device capable of communicating over a network. In an exemplary embodiment of the present invention, the communication devices 109 are similar to the computer system 210 described below with reference to FIG. 2. Similar to wireless communication devices 103, each communication device 109 connects communicatively to a communications network 112, through the use of the communication device's 109 network interface and other appropriate hardware and software components, for the bi-directional communication of data therewith. The number of communication devices 109 may vary depending upon the number of users accessing the mobile field inspection system and, therefore, the communications network environment 100 is not limited to the two communication devices 109A,Z as shown in FIG. 1. The communication network 112 may be similarly configured as the wireless communication network 106, described above.

The communications network environment 100 may also include a server system 115 configured with software and hardware similar to the computer system illustrated in FIG. 2. The server system 115 communicatively connects to the communication networks 106, 112 and, therefore, may receive and transfer data therewith. One skilled in the art will recognize that a server system 115 is generally a computer or device on a communication network 106, 112 that manages network resources. A server system 115 is often a dedicated device and, therefore, does not perform tasks besides those the server system 115 has been dedicated to perform. Additionally, the present invention may be implemented on a distributed system and, therefore, a plurality of server systems 115 may be utilized within the communications network environment 100.

In an exemplary embodiment of the present invention, the mobile field inspection system is configured for the management of facility maintenance. Facility maintenance generally includes janitorial, security, lighting, and temporary labor services to commercial, industrial, institutional, and retail facilities. Accordingly, the server system 115 may comprise various components customized for the management of facility maintenance, including a security module 118, dispatch engine 121, survey manager module 124, event monitor 127, system scheduler 130, reporting module 133, and web services module 136. The security module 118, dispatch engine 121, survey manager module 124, event monitor 127, system scheduler 130, reporting module 133, and web services module 136 may comprise hardware and software appropriate to perform tasks and provide capabilities and functionality as described herein.

The security module 118 may be adapted to authenticate users of the communication devices 103, 109. The security module 118 may determine whether a particular user is allowed access to the resources of the server system 115 and, more specifically, may determine which resources of the server system 115 the user is permitted to utilize. Accordingly, users of the mobile field inspection system may be categorized as having different levels (or permission schemes) of access to the server system 115. The different levels of users may also be hierarchical so that one user (e.g., manager) may control or supervise several other users. One skilled in the art will recognize that there exist various authentication and authorization mechanisms that may be used within the scope of the present invention. For example and not limitation, the security module 118 may authenticate a username and password provided by the user of a communication device 103, 109. A storage device 145 may comprise a table of valid usernames, passwords, and permission access levels that may be verified with the user provided data by the security module 118. Other forms of authentication and authorization may include, but are not limited to, digital certificates, digital signatures, biometric analysis, device recognition (e.g., media access control (MAC) address), and other convenient forms of existing or later developed authentication and authorization mechanisms. The security module 118 may utilize the user interface capabilities of the web services module 136 (described below) to assist in acquiring authentication and authorization data from the user of a communication device 103, 109.

The dispatch engine 121 may be adapted to generate work orders or inspection requests that may be provided to users (e.g., employees) of the communication devices 103, 109 when a service or inspection has been requested, a service or inspection is required, or a deficiency has been discovered. Any work orders or inspection requests generated by the dispatch engine 121 may be stored in the storage unit 145. The dispatch engine 121 may be activated manually by a user via a communication device 103, 109 or may be activated automatically when an event monitor 127 (described below) determines that a deficiency has been discovered and needs to be addressed. For example and not limitation, a customer may request that the carpet on a particular floor of a facility be cleaned. Such a request may be made by the customer via a communication device 103, 109 and the web services module 136 of the server system 115. Once the request has been processed, the dispatch engine 121 may generate a work order with a due date and may provide the work order to an employee working at the facility. The employee may receive the work order via a wireless communication device 103 and may then begin the requested service. Alternatively, an inspection may indicate that a restroom on a particular floor of the facility has not been cleaned. The event monitor 127 may be automatically triggered by the deficiency and may make a request to the dispatch engine 121 to generate a work order for the deficiency. The dispatch engine 121 may then provide the work order to an employee working at the facility.

The survey manager module 124 may be adapted to generate a site survey used during an onsite visit of the facility. The data collected with the site survey may assist in the development of system design specifications used to optimize the services conducted at the facility. The survey manager module 124 may provide the site survey to an employee of the facility services company over a communication network 106, 112. The employee conducting the onsite visit of the facility may use a wireless communication device 103 to collect site survey data and provide the collected site survey data to the server system 115 to be stored on the storage device 145.

The event monitor 127 may be adapted to monitor for predetermined data within the storage unit 145. When the predetermined data has been discovered, the event monitor 127 may be triggered to perform particular functions. For example and not limitation, the event monitor 127 may monitor the storage unit 145 for inspection data that indicates that a deficiency or issue has been detected. If the event monitor 127 determines that a deficiency or issue has been detected during an inspection of the facility, then the event monitor 127 may request the dispatch engine 121 to generate a work order designed specifically to address (e.g., resolve) the deficiency or issue. Additionally, the event monitor 127 may be adapted request the dispatch engine 121 to generate communications to appropriate employees or a customer concerning the work order, deficiencies, or issues. Additionally, the event monitor 127 may be triggered by a request made by a customer or employee via the web services module 136 (described below). For example and not limitation, a customer may request a special service be performed at the facility via a communication device 103, 109. The request received by the web services module 136 may be provided to the event monitor 127 which may then request the dispatch engine 121 to produce a work order specific to the provided request.

The system scheduler 130 may be adapted to schedule when certain events or services may occur. The system scheduler 130 may thus be used to create due dates of all work orders produced by the dispatch engine 121 and/or requested by the event monitor 127. Additionally, the system scheduler 130 may be further adapted to schedule all services to be conducted at the facility (e.g., cleaning program) on any given day of the year. The system scheduler 130 may ensure that the provided services are conducted on a regular basis within the facility. Each employee of the facility services company may be able to download from the server system 115 a particular day's schedule of services (e.g., the cleaning program for the day) via the wireless communication device 103.

The reporting module 133 may be adapted to generate various reports based on the data stored on the storage device 145. The reports generated by the reporting module 133 may include, but are not limited to, inspections, performance reports of a particular employee, reports on the frequency of deficiencies and issues (e.g., number and type of deficiency and/or issue), reports on the response time of a work order, and any other convenient report that may be useful in the management of facility services. One skilled in the art will recognize that reports may be generated in a variety of formats and configurations.

The web services module 136 may be adapted to provide a user interface to facilitate use of the other components of the server system 115. More specifically, the web services module 136 may provide an interface for receiving user input, displaying data stored on the storage device 145, and providing data generated by the security module 118, dispatch engine 121, survey manager module 124, event monitor 127, system scheduler 130, and reporting module 133 (e.g., other components of the server system 115). For example and not limitation, the web services module 136 may accept requests by a customer for additional services to be performed at the facility. The web services module 136 receives the input data from the user and provides it to the storage device 145 for storage. The web services module 136 may also be adapted to provide received or stored data to the other components of the server system 115 for processing. Additionally, the web services module 136 may provide a user with reports generated by the reporting module 133, such as reports of services rendered or reports of deficiencies and issues discovered. The web services module 136 may also be adapted to provide interfaces for employees conducting inspections or performing services and utilizing a wireless communication device 103. For example and not limitation, the web services module 136 may provide an employee with an inspection to conduct at a particular facility. As the employee enters notes, scans barcodes, and provides other inspection data, the web services module 136 receives the inspection data and provides it to the server system 115 for storage on the storage device 145. One skilled in the art will recognize that user interfaces may be designed and configured in various ways and may be adapted to display and receive various forms of data.

The storage device 145 stores data associated with the mobile field inspection system. Such data includes, but it not limited to, username and password data, user access level data, task lists, inspection forms, inspection data, work order data, employee data, customer data, facility data, equipment data, services data, user performance data, report data, and deficiency data. All data provided by the user via a communication device 103, 109 and all data generated by the components of the server system 115 may be stored on the storage device 145. The storage device 145 comprises a memory device capable of storing and retrieving data including, but not limited to, random access memory (RAM), flash memory, magnetic memory devices, optical memory devices, hard disk drives, removable volatile or non-volatile memory devices, optical storage mediums, magnetic storage mediums, or RAM memory cards. Alternatively, the storage device 145 may comprise a remote storage facility accessible through a wired and/or wireless network system. Additionally, the storage device 145 may comprise a memory system including a multi-stage system of primary and secondary memory devices, as described above. The primary memory device and secondary memory device may operate as a cache for each other or the second memory device may serve as a backup to the primary memory device. In yet another arrangement, the storage device 145 may comprise a memory device configured as a simple database file or as a searchable, relational database using a query language, such as SQL. One skilled in the art will recognize that the storage device 145 may reside on the server system 115 or may reside on a remote system that is accessible by the server system 115.

One skilled in the art will recognize that connecting communicatively may include any appropriate type of connection including, but not limited to, analog, digital, wireless and wired communication channels. Such communication channels include, but are not limited to, copper wire, optical fiber, radio frequency, infrared, satellite, or other media.

FIG. 2 displays a block diagram representation of an exemplary computing environment 200 in which the present invention may be implemented. Although in the context of portions of an exemplary environment, the invention may be described as consisting of instructions within a software program being executed by a processing unit, those skilled in the art will understand that portions of an exemplary embodiment of the present invention, or the entire invention itself may also be implemented by using hardware components, state machines, or a combination of any of these techniques. In addition, a software program implementing an embodiment of the present invention may run as a stand-alone program or as a software module, routine, or function call, operating in conjunction with an operating system, another program, system call, interrupt routine, library routine, or the like. The term program module may be used to refer to software programs, routines, functions, macros, data, data structures, or any set of machine readable instructions or object code, or software instructions that may be compiled into such, and executed by a processing unit 212.

Those skilled in the art will appreciate that the computing environment 200 illustrated in FIG. 2 may take on many forms and may be directed towards performing a variety of functions. Generally, the computing environment 200 illustrated in FIG. 2 may be any system that includes a computer processor. Examples of such forms and functions include, but are not limited to, personal computers, hand-held devices such as personal data assistants, note-book computers, mobile telephones, lap-top computers, mainframe computers, servers and a variety of other applications, each of which may serve as an exemplary environment for embodiments of the present invention.

The exemplary computing device 210 (e.g., wireless communication device 103 and communication device 109) may comprise various components including, but not limited to, a processing unit 212, non-volatile memory 214, volatile memory 216, and a system bus 218 that couples the non-volatile memory 214 and volatile memory 216 to the processing unit 212. The non-volatile memory 214 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, battery backed random access memory (RAM), CDROM, digital versatile disks (DVD) or other optical disk storage, magnetic cassettes, magnetic tape, magneto-optical storage devices, magnetic disk storage or other magnetic storage devices, or any other medium which may be used to store the desired information. The non-volatile memory 214 may provide storage for power-on and reset routines (bootstrap routines) that are invoked upon applying power or resetting the computing device 210. In some configurations the non-volatile memory 214 may provide the basic input/output system (BIOS) routines that may be utilized to perform the transfer of information between elements within the various components of the computing device 210.

The volatile memory 216 may include, but is not limited to, a variety of memory types and devices including, but not limited to, random access memory (RAM), dynamic random access memory (DRAM), bubble memory, registers, or the like. The volatile memory 216 may provide temporary storage for routines, modules, functions, macros, data etc. that are being or may be executed by, or are being accessed or modified by, the processing unit 212.

Alternatively, the non-volatile memory 214 and/or the volatile memory 216 may comprise a remote storage facility accessible through a wired and/or wireless network system. Additionally, the non-volatile memory 214 and/or the volatile memory 216 may comprise a memory system comprising a multi-stage system of primary and secondary memory devices, as described above. The primary memory device and secondary memory device may operate as a cache for the other or the second memory device may serve as a backup to the primary memory device. In yet another arrangement, the non-volatile memory 214 and/or the volatile memory 216 may comprise a memory device configured as a simple database file or as a searchable, relational database using a query language, such as SQL.

The computing device 210 may access one or more external display devices 230 such as a CRT monitor, LCD panel, LED panel, electro-luminescent panel, or other display device, for the purpose of providing information or computing results to a user. In some embodiments, the external display device 230 may actually be incorporated into the product itself. The processing unit 212 may interface to each display device 230 through a video interface 220 coupled to the processing unit 210 over the system bus 218.

The computing device 210 may send output information, in addition to the display 230, to one or more output devices 236 such as a speaker, modem, printer, plotter, facsimile machine, RF or infrared transmitter, computer or any other of a variety of devices that may be controlled by the computing device 210. The processing unit 212 may interface to each output device 236 through an output interface 226 coupled to the processing unit 212 over the system bus 218.

The computing device 210 may receive input or commands from one or more input devices 234 such as a keyboard, pointing device, mouse, modem, RF or infrared receiver, microphone, joystick, track ball, light pen, game pad, scanner, camera, computer or the like. The processing unit 212 may interface to each input device 234 through an input interface 224 coupled to the processing unit 212 over the system bus 218.

It will be appreciated that program modules implementing various embodiments of the present invention may be stored in the non-volatile memory 214, the volatile memory 216, or in a remote memory storage device accessible through the output interface 226 and the input interface 224. The program modules may include an operating system, application programs, other program modules, and program data. The processing unit 212 may access various portions of the program modules in response to the various instructions contained therein, as well as under the direction of events occurring or being received over the input interface 224.

The computing device 210 may provide data to and receive data from one or more other storage devices 232, which may provide volatile or non-volatile memory for storage and which may be accessed by computing device 210. The processing unit 212 may interface to each storage device 232 through a storage interface 222 over the system bus 218.

The interfaces 220, 222, 224, 226, and 228 may include one or more of a variety of interfaces, including but not limited to, cable modems, DSL, T1, V series modems, an RS-232 serial port interface or other serial port interface, a parallel port interface, a universal serial bus (USB), a general purpose interface bus (GPIB), an optical interface such as infrared or IrDA, an RF or wireless interface such as Bluetooth, or other interface.

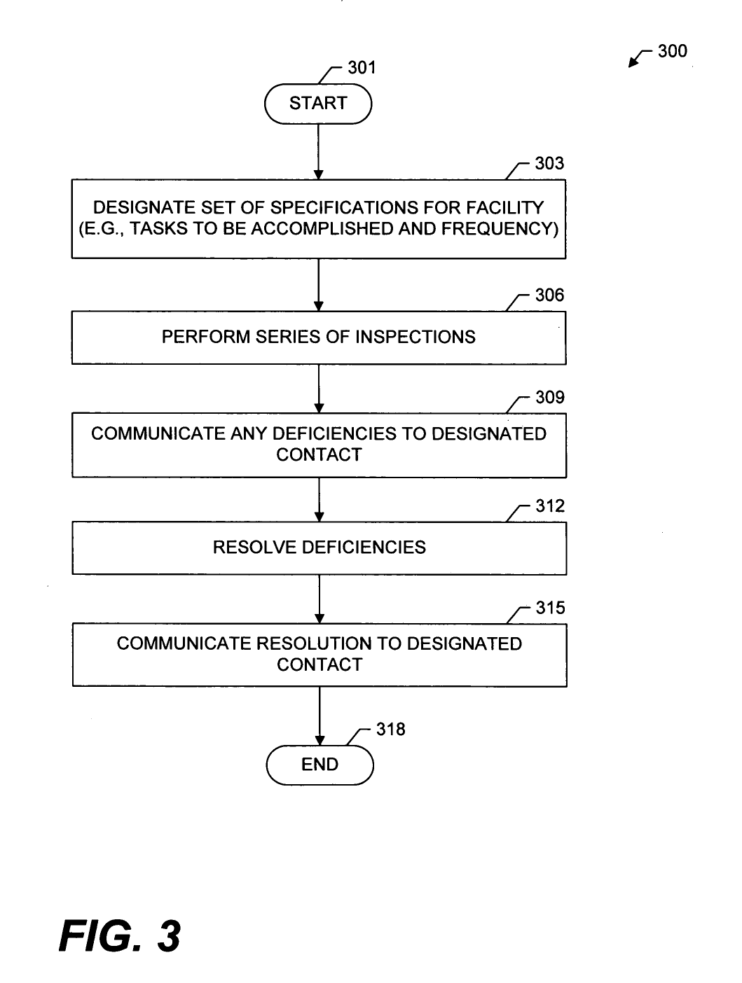

FIG. 3 displays a flowchart representation of a method 300 of quality management for janitorial services in accordance with an exemplary embodiment of the present invention. A communications network environment 100 (as described in FIG. 1) may be used in combination with a method 300 of quality management for janitorial services to provide effective and efficient services to the customer. Such a combination ensures that the method 300 is followed appropriately and that deficiencies and issues are resolved in a timely manner. Additionally, the constant proactive communication between the facilities services company and the customer may provide an additional benefit.

After starting at step 301, the facility services manager proceeds to step 303 where the facility services manager, with the assistance of the customer, designates a set of specifications 303 for a particular facility. The set of specifications are generally determined during the bid or initial contract process between the customer and the facility services company. The set of specifications may include, but are not limited to, the tasks to be accomplished (e.g., services to be provided) and the frequency the tasks are to be performed at the facility. The set of specifications (sometimes referred to as the “cleaning program”) determine what tasks are performed by the employees of the facility services company and the frequency in which the tasks are to be performed. In an exemplary embodiment of the present invention, the employees of the facility services company are equipped with wireless communication devices 103 (e.g., handheld computers) comprising scanning devices 148. The facility services company may create a specific procedure for performing the cleaning program for each employee. The employees may download the procedure and cleaning program from the system server 115 via the wireless communication network 106. Additionally, to facilitate a mechanism for accountability and management of the employees and services, the facility services company may incorporate barcodes through the facility. As the employees perform a particular task from the cleaning program, the employees may scan a barcode with the scanning device 148 of the wireless communication device 103. The data from the scan (along with a timestamp) may be provided to the server system 115 and stored in the storage device 145. For example and not limitation, each restroom within the facility may be fitted with barcodes located in various places (e.g., soap dispensers, paper towel dispensers, and toilet paper dispensers). As an employee determines whether the restroom needs to be restocked with various supplies, the employee may scan the barcodes and, thus, indicates that the employee has performed a particular task. The scanning of the barcode (which also produces a timestamp of when the scanning took place) provides the facility services manager with an indication of when an employee performed a particular service within the facility.

After the facility services company begins providing the services and tasks set forth in the specifications (e.g., cleaning program), the facility services manager may need to determine whether the tasks and services within the cleaning program are being performed adequately by the employees of the facility services company. Accordingly, at step 306, the facility services manager may perform a series of inspections. The inspections generally require the facility services manager (or other determined employee of the facility services company) to conduct a walkthrough within the facility. The inspections not only discover deficiencies within janitorial services provided by the employees of the facility services company, but may also discover maintenance and engineering issues. In an exemplary embodiment of the present invention, the facility services manager or other appropriate employee is equipped with a wireless communication device 103 including a scanning device 148. Therefore, during the inspection the facility services manager or other appropriate employee may take notes as to any deficiencies in the services provided at the facility. Additionally, the facility services manager or other appropriate employee may scan barcodes that have been previously dispersed throughout the facility, so that particular services may be addressed. For example and not limitation, a barcode may be placed on the paper towel dispensers located in every restroom within the facility. As the facility service manager or other appropriate employee inspects a paper towel dispenser on a particular floor of the facility, the barcode may be scanned. The barcode identifies which paper towel dispenser is being inspected and, therefore, any notes provided by the facility services manager or other appropriate employee may be associated with the particular paper towel dispensers. Additionally, a timestamp may be generated during the scanning of the barcode, indicating the date and time of when the paper towel dispenser was inspected. The barcode data (with timestamp) and submitted notes (e.g., the inspection data) may be provided by the wireless communication device 103 to the server system 115 to be stored on the storage unit 145.

Next, at step 309, any deficiencies and/or issues discovered during the inspection are communicated to the responsible party (e.g., an employee of the facility services company or the customer). Maintenance and engineering issues, while not within the set of specifications (e.g., cleaning program) may be used to cross-sell additional services to the customer. The communication of the deficiencies and/or issues may be accomplished manually or automatically. For example and not limitation, a deficiency or issue discovered during the inspection may be alerted to the facility services manager who may notify the responsible party (e.g., by phone, letter, facsimile, or e-mail). Then, a work order may be created by the facility services manager and sent to the appropriate employee to perform a particular task (e.g., fulfill the work order) by a predetermined due date. Additionally, the customer may be informed of maintenance and engineering issues that are not addressed in the cleaning program, thus providing a mechanism for selling additional services to the customer. Alternatively, once the deficiency has been digitally recorded on the wireless communication device 103 and the inspection data has been transferred to the server system 115 for storage, the event monitor 127 may examine the inspection data and discover all deficiencies and/or issues. The event monitor 127 may then request the dispatch engine 121 to generate a work order, wherein the due date may be determined by the system scheduler 130. The dispatch engine 121 may then provide the work order and due date to the appropriate party via e-mail or other appropriate communication methodology.

At step 312, the deficiencies or issues discovered during the inspection are resolved. After receiving the work order (e.g., alert of a deficiency), the employee of the facility service company may complete the services and, therefore, resolve the deficiency by the set due date. The resolution of the deficiency may be recorded on a wireless communication device 103 and, therefore, the service data may be recorded in the database 145 through the server system 115.

At step 315, a communication is generated to the appropriate party (e.g., designated contact) indicating that the deficiencies and/or issues have been resolved. Similar to the communication generated at step 309, the generation of this communication may be conducted manually or automatically. For example and not limitation, resolution of the deficiency or issue discovered during the inspection may be alerted to the facility services manager who may notify the responsible party (e.g., by phone, letter, facsimile, or e-mail). Alternatively, once the resolution of the deficiency has been digitally recorded on the wireless communication device 103 and the service data has been transferred to the server system 115 for storage, the event monitor 127 may examine the inspection data and discover that the deficiencies and/or issues have been resolved. The event monitor 127 may then provide a message indicating that the deficiencies and/or issues have been resolved to the appropriate party via e-mail or other appropriate communication methodology. The process is terminated in accordance with method 300 at step 318.

Table 1 illustrates an exemplary time table of the tentative project development tasks that may be used in the implementation of the present invention. Once the facility services company and the customer agree on a series of specifications (e.g., tasks to be performed and the frequency to perform the tasks), the purchase order for the proposal may be determined (Step 1, Week 1). After an analysis of the types of services to be conducted at the facility, the necessary equipment and supplies are ordered (Step 2, Week 2) by the facility services company. To prepare the employees to be staffed at the facility, a “kick-off” meeting may be conducted (Step 3, Week 1) to educate the employees of the facility services company of the type of services to be conducted at the facility. To properly incorporate a communications network environment 100 within the facility, the facility services company (e.g., employees of the facility services company) may gather system design requirements and conduct a site survey (e.g., generated by the survey manager module) during an on-site visit of the facility (Step 4, Week 2). Based on the system design requirements gathered, the system design specifications may then be determined (Step 5, Week 3). The system design specifications may be provided for the customer for approval or comment (Step 6, Week 4). Based on the customer's comments and recommendations, the design specification is finalized and the system scheduler 130 may generate a system development schedule (Step 7, Week 5). Next, the development of the system is begun (Step 8, Week 5). As the system is being developed, the customer is updated on the progress of the development (Step 9, Week 6). The system network (e.g., the communications network environment 100) is installed and/or verified (Step 10, Week 7). The customer is again updated on the progress of the system development (Step 11, Week 7). The system is then completed and remote testing is conducted (Step 12, Week 11). After the remote testing of the communications network environment 100, an environmental test is conducted during an onsite visit to the facility (Step 13, Week 12). After the communications network environment 100 (e.g., system) has been tested, the use of the system is implemented and the employees are trained on using the system (Step 14, Week 13). The communications network environment 100 is then brought online for product, once the employees have been trained (Step 15, Week 14). Finally, all of the employees may be provided hands-on and hands-off training of the system (e.g., communications network environment 100) and the acceptance period begins for use of the system within the facility (Step 16, Week 15). The communications network environment 100, as described above, may then be used by the facility services company to provide effective and efficient services to the customer.

TABLE 1

| | | Week | | | | | | | | | | | | | | |
|---|---|---|---|---|---|---|---|---|---|---|---|---|---|---|---|---|
| Step | Description | 1 | 2 | 3 | 4 | 5 | 6 | 7 | 8 | 9 | 10 | 11 | 12 | 13 | 14 | 15 |
| 1 | Purchase Order for | X | | | | | | | | | | | | | | |
| | agreed upon | | | | | | | | | | | | | | | |
| | proposal | | | | | | | | | | | | | | | |
| | determined. | | | | | | | | | | | | | | | |
| 2 | Equipment | X | | | | | | | | | | | | | | |
| | ordered for | | | | | | | | | | | | | | | |
| | services. | | | | | | | | | | | | | | | |
| 3 | Kick-off meeting | X | | | | | | | | | | | | | | |
| | with employees. | | | | | | | | | | | | | | | |
| 4 | Gather system | | X | | | | | | | | | | | | | |
| | design | | | | | | | | | | | | | | | |
| | requirements and | | | | | | | | | | | | | | | |
| | perform site | | | | | | | | | | | | | | | |
| | survey during on- | | | | | | | | | | | | | | | |
| | site visit. | | | | | | | | | | | | | | | |
| 5 | Begin system | | | X | | | | | | | | | | | | |
| | design | | | | | | | | | | | | | | | |
| | specifications. | | | | | | | | | | | | | | | |
| 6 | Provide design | | | | X | | | | | | | | | | | |
| | update to | | | | | | | | | | | | | | | |
| | customer. | | | | | | | | | | | | | | | |
| 7 | Finalize design | | | | | X | | | | | | | | | | |
| | specification, | | | | | | | | | | | | | | | |
| | provide system | | | | | | | | | | | | | | | |
| | development | | | | | | | | | | | | | | | |
| | schedule. | | | | | | | | | | | | | | | |
| 8 | Begin system | | | | | X | | | | | | | | | | |
| | development. | | | | | | | | | | | | | | | |
| 9 | Provide | | | | | | X | | | | | | | | | |
| | development | | | | | | | | | | | | | | | |
| | update to | | | | | | | | | | | | | | | |
| | customer. | | | | | | | | | | | | | | | |
| 10 | Install or verify | | | | | | | X | | | | | | | | |
| | network. | | | | | | | | | | | | | | | |
| 11 | Provide | | | | | | | X | | | | | | | | |
| | development | | | | | | | | | | | | | | | |
| | update to | | | | | | | | | | | | | | | |
| | customer. | | | | | | | | | | | | | | | |
| 12 | Complete | | | | | | | | | | | X | | | | |
| | development and | | | | | | | | | | | | | | | |
| | remote testing. | | | | | | | | | | | | | | | |
| 13 | Perform | | | | | | | | | | | | X | | | |
| | environmental | | | | | | | | | | | | | | | |
| | testing during on- | | | | | | | | | | | | | | | |
| | site visit. | | | | | | | | | | | | | | | |
| 14 | Begin | | | | | | | | | | | | | X | | |
| | implementation | | | | | | | | | | | | | | | |
| | and training of | | | | | | | | | | | | | | | |
| | system. | | | | | | | | | | | | | | | |
| 15 | Bring system | | | | | | | | | | | | | | X | |
| | online. | | | | | | | | | | | | | | | |
| 16 | Complete hands- | | | | | | | | | | | | | | | X |
| | on and hands-off | | | | | | | | | | | | | | | |
| | training of system; | | | | | | | | | | | | | | | |
| | acceptance period | | | | | | | | | | | | | | | |
| | begins. | | | | | | | | | | | | | | | |

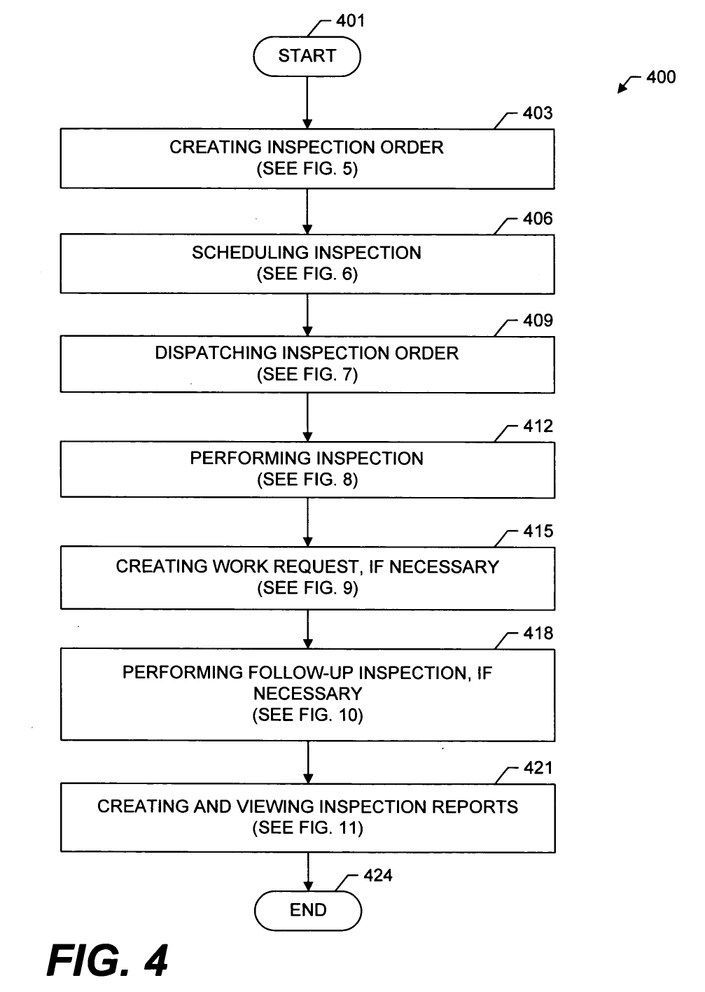

FIG. 4 displays a flowchart representation of a method 400 of managing inspections for janitorial services in accordance with an exemplary embodiment of the present invention. An important aspect of the management of facility services is the creation and application of facility inspections. Inspections may be used to determine whether the services provided by the facility services company are being performed properly (e.g., qualitatively and quantitatively). Through the facility inspections deficiencies may be detected, as well as maintenance and engineering issues. Deficiencies in the services provided may then be handled appropriately by the facility services company. Maintenance and engineering issues may be used to offer additional services to a customer, so that the issues may be properly resolved.

After starting at step 401, the reporting module 133 proceeds to step 403 where the reporting module 133 creates an inspection order to be conducted at a particular facility. Next, at step 406, the system scheduler 130 sets a date and time (e.g., due date) for the inspection to be conducted at the facility (e.g., schedules the inspection). At step 409, the dispatch engine 121 dispatches the inspection to the appropriate employee. After receiving the inspection from the dispatch engine 121, the employee may, at step 412, perform the inspection at the facility and the inspection data received from the inspection may be stored on the storage device 145.

Then at step 415, the event monitor 127 examines the inspection data to determine if a deficiency or issues exists and, if so, the event monitor 127 requests the dispatch engine 121 to generate a work order to address the deficiency or issue. The dispatch engine 121 may provide the work order to an appropriate employee of the facility services company. The employee may then perform the task set out in the work order. At step 418, the reporting module 133 via the dispatch engine 121 provides the appropriate employee with a follow-up inspection to be conducted at the facility. If the inspection determines that the deficiency or issue has been resolved, then at step 421 the reporting module 133 may create inspection reports which may be provided to an employee or the customer for viewing. The reporting module 133 then terminates operation in accordance with method 400 at step 424.

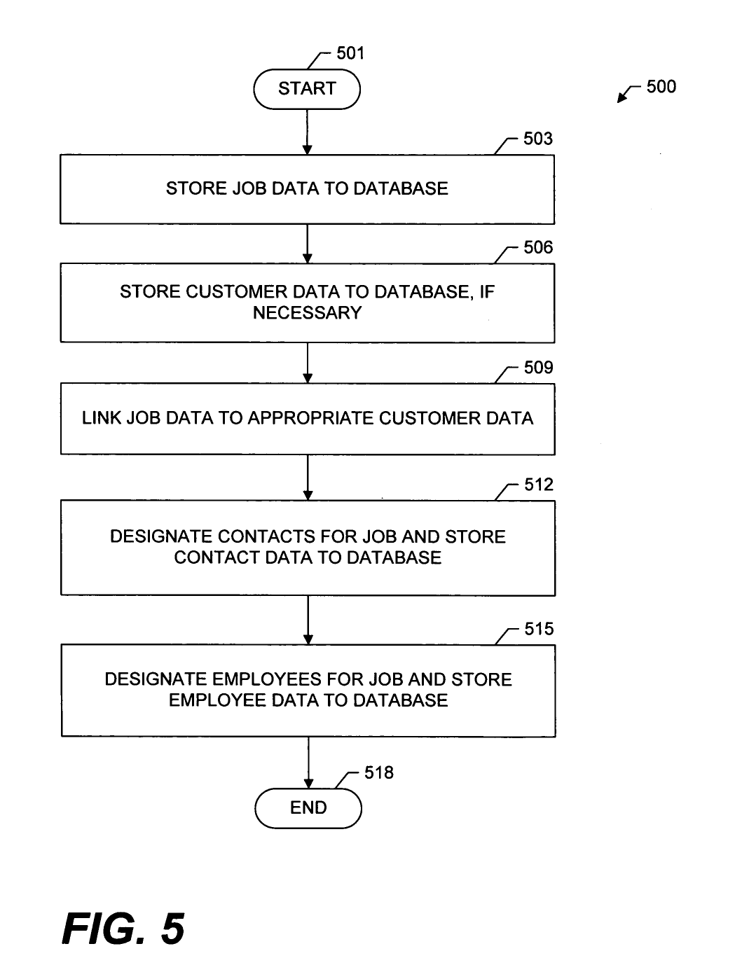

FIG. 5 displays a flowchart representation of a method 500 of creating an inspection order in accordance with an exemplary embodiment of the present invention. Before an inspection of a facility may be created by the reporting module 133, a purchase order (e.g., job) must exist and be associated with a particular customer.

After starting at step 501, the web services module 136 proceeds to step 503 where the web services module 136 receives job data from a user of a communication device 103, 109 and stores the job data on the storage unit 146 (e.g., database). Next, at step 506 the web services module 136 receives customer data from a user of a communication device 103, 109 and stores the customer data on the storage unit 146, if necessary. If the customer data already exists within the storage unit 145, then step 506 may be skipped. At step 509, the web services module 136 links the job data to the appropriate customer data within the storage unit 145. One skilled in the art will recognize that linking job data with customer data may include, but is not limited to, associating a customer identification number with job data within the storage unit 145 (e.g., the job data includes a field for identifying the customer associated with the job). Then, at step 512, the web services module 136 may receive contact data from a user of a communication device 103, 109 and provide the contact data to the storage unit 145 for storage. The contact data represents an individual or entity in which communication is to be directed from the facility services system (e.g., regarding the services provided at the facility). At step 515, the web services module 136 may receive employee data which identifies the employees that will be conducting services at a particular facility. The web services module 136 provides the employee data to the storage unit 145 for storage. The web services module 136 then halts operation in accordance with method 500 at step 515.

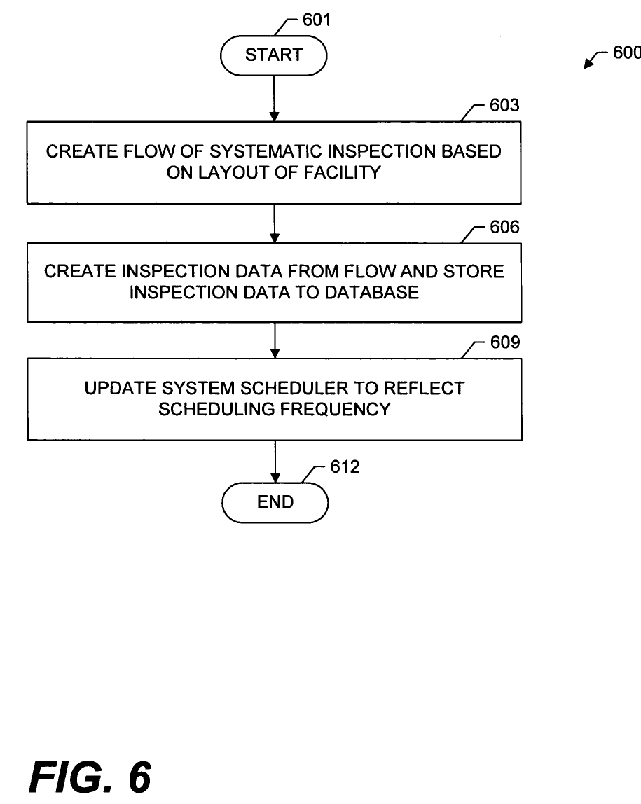

FIG. 6 displays a flowchart representation of a method 600 of scheduling an inspection in accordance with an exemplary embodiment of the present invention. After a job has been associated with a customer, facility, and employees, the inspection for a particular facility may be created and scheduled.

After staring at step 601, the survey manager module 124 proceeds to step 603 where the survey manager module 124 determines an appropriate flow for a systematic inspection based on the layout of a particular facility. The layout of a particular facility may be provided during initialization of the customer data (as described above with reference to FIG. 5) or may be collected by the web services module 136 via a communication device 103, 109 and stored on the storage device 145 prior to the determination of an appropriate flow for a systematic inspection. After determining a flow for a systematic inspection, the reporting module 133 proceeds to step 606 where the reporting module 133 creates an inspection from the flow for a systematic inspection. The inspection may be provided by the survey manager module 124 to the storage device 145 for storage. Next, at step 609, the system scheduler 130 updates the system schedule to reflect the scheduling frequency of the inspection (e.g., how often the inspection may be conducted at the particular facility). The reporting module 133 then stops operation in accordance with method 600 at step 612.

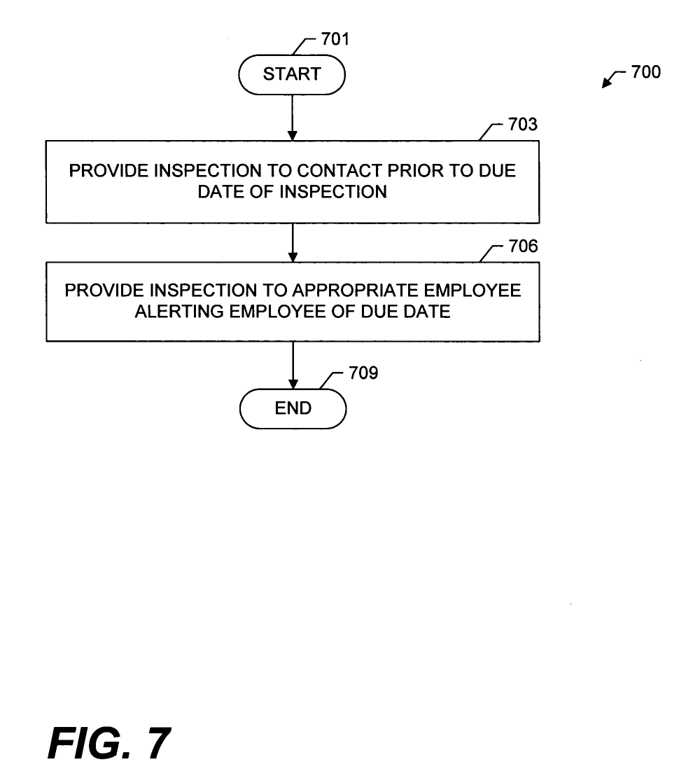

FIG. 7 displays a flowchart representation of a method 700 of dispatching an inspection order in accordance with an exemplary embodiment of the present invention. Once an inspection has been created and scheduled, the inspection may be dispatched to an employee of the facility services company. The dispatch typically occurs a predetermined time period prior to the due date of the inspection (e.g., a week before the inspection is due).

After starting at step 701, the dispatch engine 121 proceeds to step 703 where the dispatch engine 121 requests an inspection due date from the system scheduler 130 and provides the inspection and due date to the contact (e.g., customer) designated in the customer data stored on the storage unit 145. This communication by the dispatch engine 121 to the customer provides a valuable communication alerting the customer that an inspection is to be performed. Next at step 706, the dispatch engine 121 provides the inspection and due date to an appropriate employee of the facility services company. The dispatch engine 121 generally provides the inspection and due date to an appropriate employee a predetermined period of time prior to the due date of the inspection. The dispatch engine 121 then terminates operation in accordance with method 700 at step 709.

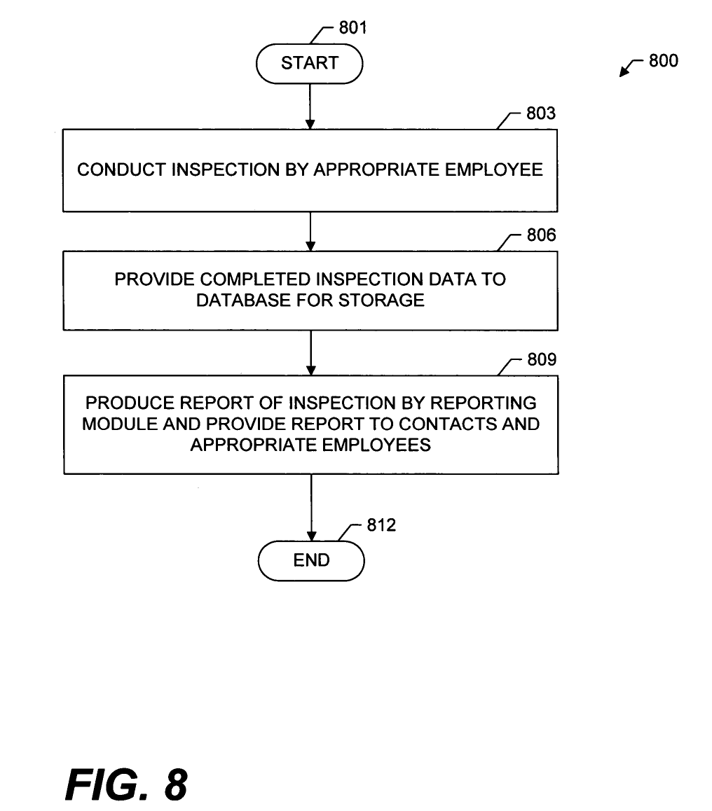

FIG. 8 displays a flowchart representation of a method 800 of performing an inspection in accordance with an exemplary embodiment of the present invention. After the inspection and due date has been dispatched to the appropriate employee of the facility services company, the inspection may be conducted by the appropriate employee and, thus, inspection data may be collected.

After beginning at step 801, the appropriate employee, at step 803, may conduct the inspection prior to the due date generated by the system scheduler 130. Next at step 806, the web services module 136 receives inspection data from the employee via the wireless communication device 103 and provides the inspection data to the storage unit 145 for storage. Then at step 809, the reporting module 133 generates a report of the inspection and the dispatch engine 121 provides the generated report to the designated contact (e.g., customer) and the appropriate employees (e.g., facility service manager). The reporting module 133 then stops operation in accordance with method 800 at step 812.

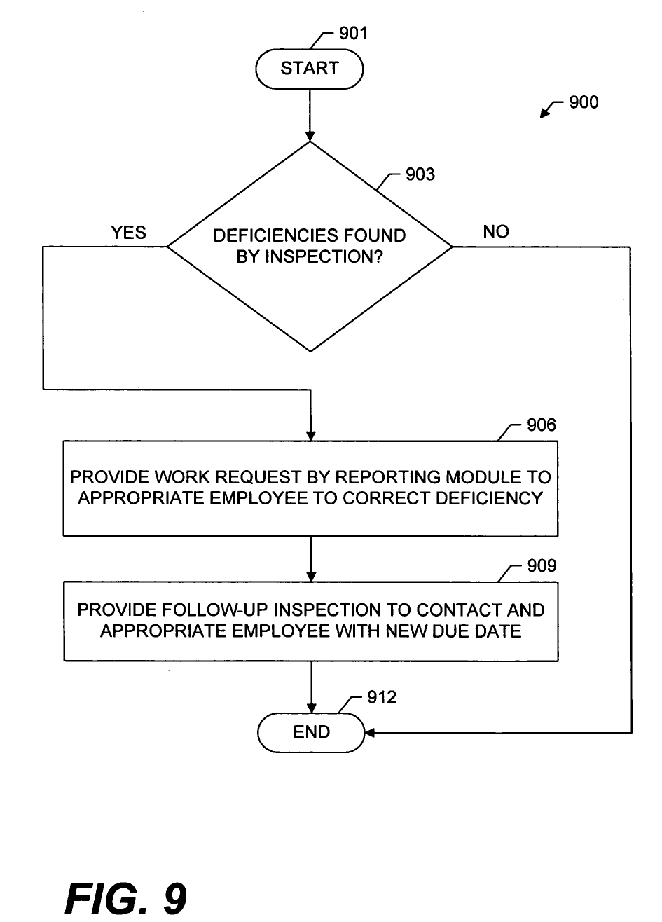

FIG. 9 displays a flowchart representation of a method 900 of creating a work request in accordance with an exemplary embodiment of the present invention. After an inspection has been performed and any deficiencies or issues noted, a work order may be generated to resolve the deficiencies or issues discovered during the inspection.

After starting at step 901, the event monitor 127 proceeds to step 903 where the event monitor 127 determines whether any deficiencies were found by the inspection. The event monitor 127 may analyze the inspection data stored on the storage unit 145 and, thus, determine whether a deficiency or issue has been noted by the appropriate employee of the facility services company. If at step 903, the event monitor 127 determines that no deficiencies have been found during the inspection of the facility then the event monitor 127 terminates operation in accordance with method 900 at step 912. Otherwise, if at step 903 the event monitor 127 determines that deficiencies have been discovered during the inspection of the facility, then the reporting module 133 proceeds to step 906 where the reporting module 133 generates a work order to remedy the deficiency and the event monitor 127 requests the dispatch engine 121 to provide the work order to the appropriate employee. The employee of facility services company may then perform the task outlined in the work order. Next, at step 909, the dispatch engine 121 may provide a follow-up inspection to the contact (e.g., customer) and appropriate employee with a new due date generated by the system scheduler 130. The dispatch engine 121 then halts operation in accordance with method 900 at step 912.

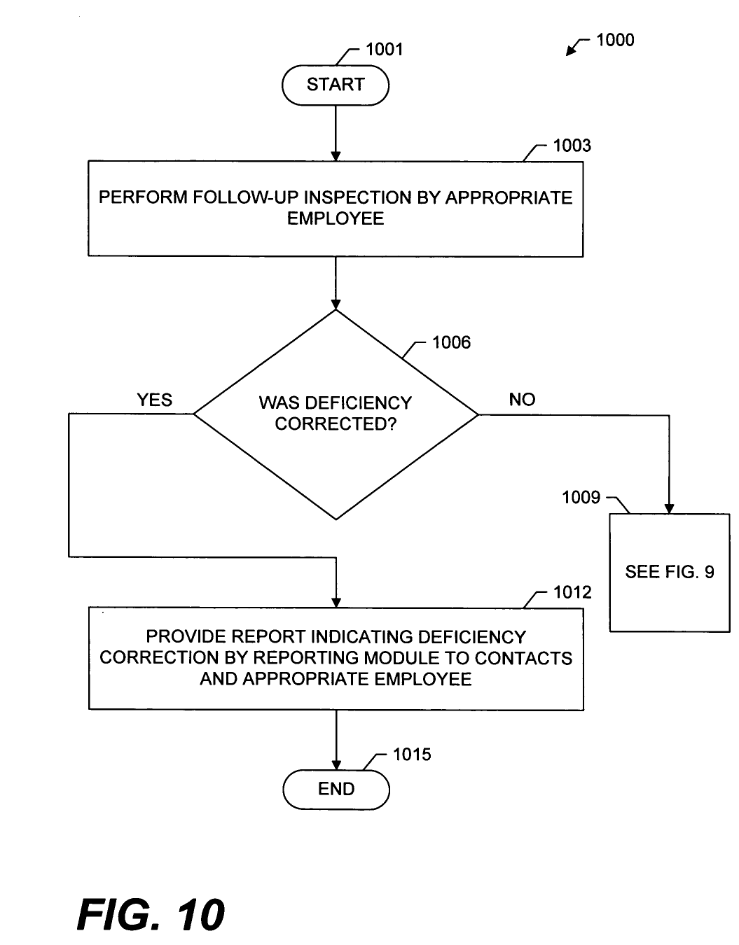

FIG. 10 displays a flowchart representation of a method 1000 of performing a follow-up inspection in accordance with an exemplary embodiment of the present invention. After a work order has been created by the dispatch engine 121 to address a deficiency discovered during inspection, a follow-up inspection may be necessary to ensure that the deficiency has been properly resolved.

After beginning at step 1001, the dispatch engine 121 proceeds to step 1003 where the dispatch engine provides a follow-up inspection generated by the reporting module 133 to the appropriate employee and the follow-up inspection is, then, conducted by the appropriate employee. As the employee conducts the follow-up inspection, inspection data is provided by the wireless communication device 109 to the server system 115 to be stored on the storage unit 145. Next, at step 1006 the event monitor 127 determines whether the deficiency has been resolved appropriately. The event monitor 127 may analyze the follow-up inspection data to determine whether the appropriate employee has indicated that the deficiency has been properly resolved. If at step 1006, the event monitor 127 determines that the deficiency was not properly resolved then the event monitor 127 proceeds to step 1009 (see FIG. 9, described above). If, however, at step 1006 the event monitor 127 determines that the deficiency was properly resolved, then the event monitor 127 proceeds to step 1012 where the reporting module 133 generates a report indicating that the deficiency has been resolved and the dispatch engine 121 provides the generated report to the contact (e.g., customer) and the appropriate employees of the facility services company. The dispatch engine 121 then halts operation in accordance with method 1000 at step 1015.

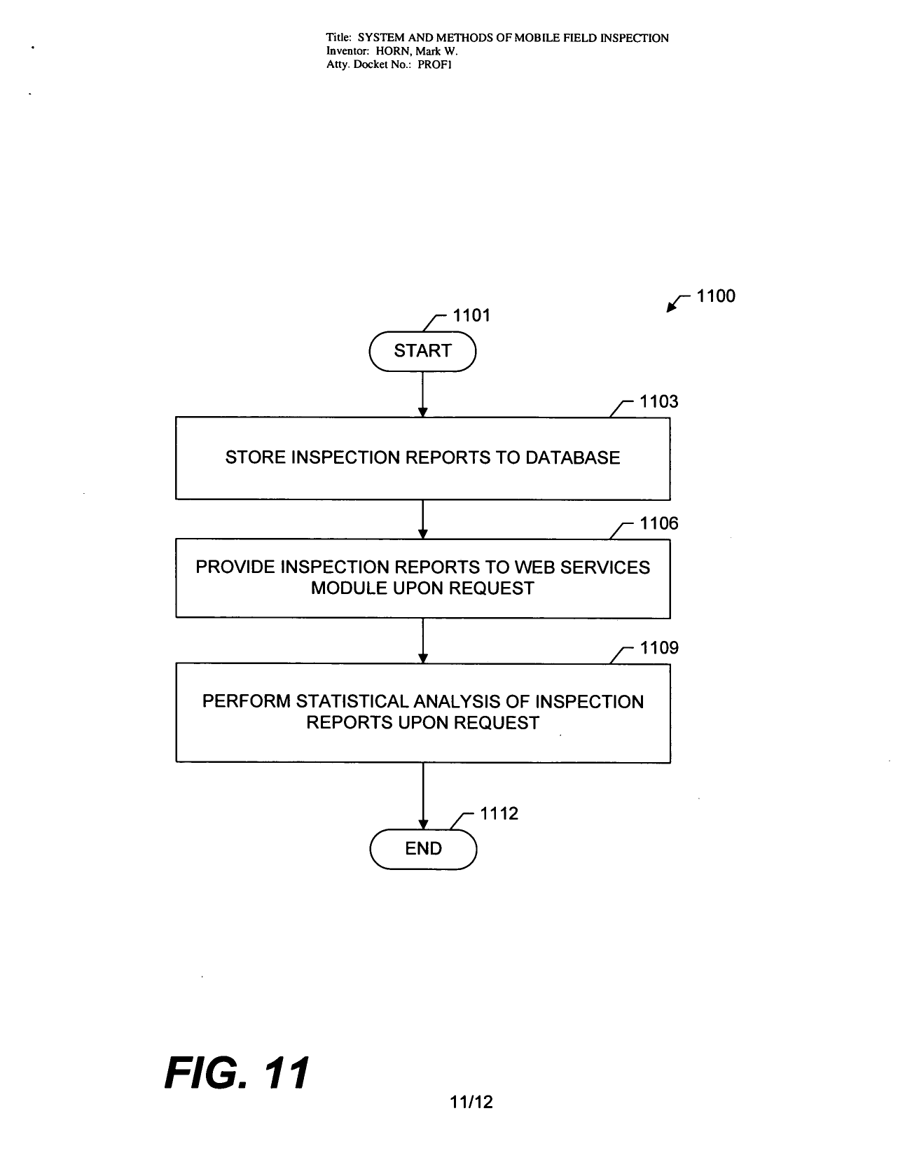

FIG. 11 displays a flowchart representation of a method 1100 of creating and viewing inspection reports in accordance with an exemplary embodiment of the present invention. After the inspection(s) have been completed, reports may be generated displaying the information collected during the inspection(s). The reports may then be viewed by the customer or appropriate employees of the facility services company.

After starting at step 1101, the reporting module 133 proceeds to step 1103 where the reporting module 133 provides the inspection reports (including the collected inspection data) to the storage unit 145 for storage. Next, at step 1106, the inspection reports and accompanying data may be provided by the storage unit 145 to the web services module 136 upon request. Then, at step 1109, the reporting module 133 may perform a statistical analysis of the inspection reports upon request from a user of a communication device 103, 109. One skilled in the art will recognize that a statistical analysis of inspection reports may be configured or conducted in a variety of ways and based on a variety of standards. The reporting module 133 then terminates operation in accordance with method 1100 at step 1112.

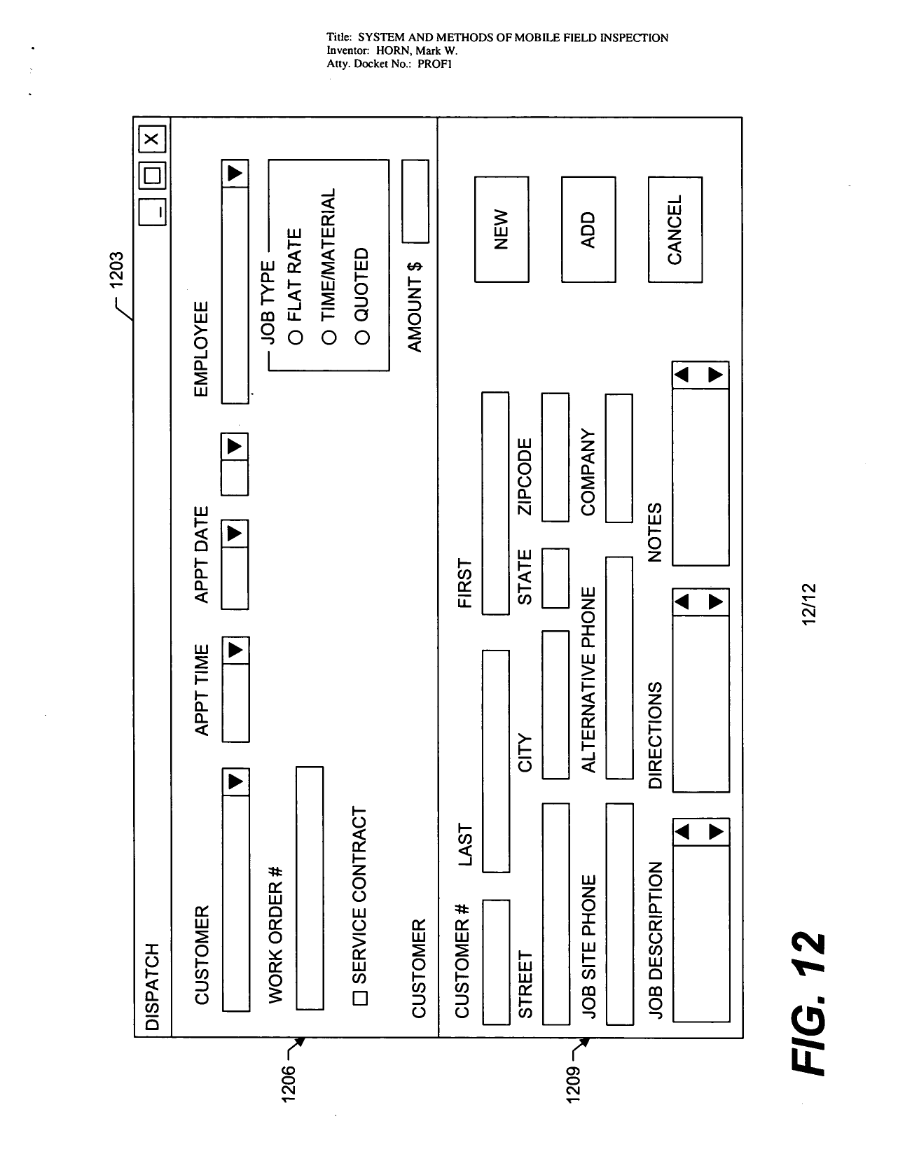

FIG. 12 displays a diagram representation of a dispatch interface 1203 to an online field inspection system in accordance with an exemplary embodiment of the present invention. As described more fully above, the web services module 136 may provide a user interface to a user via a communication device 103, 106. The web services module 136 may receive user input from a user and communicate the input to other components of the server system 115. For example and not limitation, the dispatch interface 1203 illustrated in FIG. 12 provides an interface between the user and the dispatch engine 121 and storage unit 145. The user provides certain dispatch data to the web services module 136 which may then provide the data to the storage unit 145 for storage and to the dispatch engine 121 for processing. The dispatch interface may include input fields representing dispatch information 1206 and customer information 1209. A user may then request that a certain service be provided at a particular facility. The information is submitted by the user and provided to the web services module 136. The dispatch information and customer information may then be used to create an appropriate work order by the dispatch engine 121. The dispatch engine 121 may then provide the work order to the appropriate employee of the facility services company. Accordingly, the work product request may be processed and completed in an efficient and effective manner.

The dispatch information 1206 may include, but is not limited to, a customer name, number, or other identification, the time and date of the appointment, the name of the employee to perform the service, the type of job to perform (e.g., flat rate, time/material, quoted rate), a work order number (e.g., which may be automatically generated), the amount of the service, and whether the service is based on a contractual obligation. The customer information 1209 may include a unique customer number, first and last name of the customer (e.g., or contact person), company's street address, city, state, and zipcode, the phone number of the job site, an alternative phone number, a company name, a description of the jobs or services conducted at the facility, directions to the facility, and any other notes that may be associated with the customer.

One skilled in the art will recognize that such interfaces, such as the dispatch interface 1203 displayed in FIG. 12 may be arranged in a variety of configuration (e.g., complex or simple) and may provide or request various forms of data. Accordingly, the present invention is not limited to the exemplary user interface displayed in FIG. 12.

Whereas the present invention has been described in detail it is understood that variations and modifications can be effected within the spirit and scope of the invention, as described herein before and as defined in the appended claims. The corresponding structures, materials, acts, and equivalents of all mean-plus-function elements, if any, in the claims below are intended to include any structure, material, or acts for performing the functions in combination with other claimed elements as specifically claimed.

1. A system for mobile field inspection, the system comprising:
a server system adapted to maintain a set of services to be scheduled and conducted at a first facility, wherein said server system is configured to provide a first set of tasks to a first user for performance of said set of tasks at said first facility;
a first communication device associated with said first user of said first facility, said first communication device adapted to receive said first set of tasks from said server system and provide service data to said server system.

2. The system of claim 1, wherein said first communication device comprises a scanning device adapted to scan barcodes such that each barcode represents a characteristic of at least one task of said first set of tasks.

3. The system of claim 2, wherein said first communication device is further adapted to provide scanned barcode data and a timestamp to said server system.

4. The system of claim 1, wherein said system further comprises a storage unit adapted to store service data received by said server system from said first communication device.

5. The system of claim 1, wherein said first communication device is a wireless communication device.

6. The system of claim 1, wherein said server system is further adapted to provide said first communication device with an inspection for said first facility.

7. The system of claim 6, wherein said first communication device is further adapted to provide inspection data received by said first user of said first facility to said server system.

8. The system of claim 7, wherein said server system is further adapted to
determine whether at least one service deficiency exists based on said inspection data; and
generate a second set of tasks for a second user of said facility, if said server system determines that at least one service deficiency exists.

9. A method of quality management for janitorial services, said method comprising the steps of:
designating a set of specifications for a facility;
performing a series of inspections of said facility;
providing a list of deficiencies to a predetermined contact of said facility;
resolving said list of deficiencies; and
communicating resolution of said list of deficiencies to said predetermined contact.

10. The method of claim 9, wherein designating a set of specifications for a facility comprises designating a set of tasks to be performed at said facility and determining a frequency as to which said set of tasks will be performed.

11. The method of claim 9, wherein resolving said list of deficiencies comprises generating a set of work orders associated with said list of deficiencies to be performed by a user of said facility.

12. A method of managing inspections for janitorial services, the method comprising the steps of:
creating an inspection order for a facility, wherein said inspection evaluates a list of services provided at said facility;
scheduling said inspection order;
dispatching said inspection order;
performing said inspection by a user of said facility, wherein inspection data is collected by said user;
creating a work order, if said inspection discovers a list of deficiencies in said list of services;
performing a follow-up inspection, if said work order is created; and
providing an inspection report based on said collected inspection data.

13. The method of claim 12, wherein creating an inspection order for a facility comprises the steps of:
providing job data to a storage unit for storage, wherein said job data identifies the types of services to be performed at said facility;
providing customer data to a storage unit for storage, wherein said customer data identifies a customer associated with said facility;
setting a correspondence between said job data and said customer data;
designating at least one contact to be associated with said job data; and
designating at least one user of said facility to be associated with said job data, wherein said at least one user provides services at said facility.

14. The method of claim 12, wherein scheduling said inspection order comprises the steps of:
creating a systematic inspection flow based on layout of said facility;
creating an inspection based on said systematic inspection flow;
scheduling a frequency of said inspection, wherein said frequency indicates how often said inspection is conducted.

15. The method of claim 12, wherein dispatching said inspection order comprises the steps of:
providing said inspection order to a contact associated with said facility; and
providing said inspection order to a user of said facility, wherein said user conducts said inspection order.

16. The method of claim 15, wherein the method further comprises:
providing a predetermined due date for said inspection order to said contact; and
providing said predetermined due date to said user.

17. The method of claim 12, wherein performing said inspection comprises the steps of:
conducting said inspection by said user;
providing inspection data to a storage unit for storage, wherein said inspection data is collected by said user; and
providing a report of said inspection.

18. The method of claim 12, wherein creating a work order comprises the steps of:
determining whether said inspection discovered a list of deficiencies in said list of services;
performing a first sequence, if said inspection discovered a list of deficiencies, said first sequence comprising the steps of:
providing a work order to a first employee of said facility, wherein said first employee completes said word order; and
providing a follow-up inspection to a second employee of said facility, wherein said second employee conducts said follow-up inspection.

19. The method of claim 12, wherein performing a follow-up inspection comprises the steps of:
performing said follow-up inspection by a user of said facility;
determining whether said list of deficiencies have been resolved;
providing a report indicating that said list of deficiencies have been resolved, if said list of deficiencies have been resolved.

20. The method of claim 12, wherein providing an inspection report comprises the steps of:
providing said inspection report to a storage unit;
providing said inspection report to a communication device for display; and
providing a statistical analysis of said inspection report to a communication device for display.

21. A computer-readable medium having computer-executable instructions for quality management for janitorial services, the computer-executable instructions performing the steps of:
designating a set of specifications for a facility;
performing a series of inspections of said facility;
providing a list of deficiencies to a predetermined contact of said facility;
resolving said list of deficiencies; and
communicating resolution of said list of deficiencies to said predetermined contact.

22. The computer-readable medium of claim 21, wherein designating a set of specifications for a facility comprises designating a set of tasks to be performed at said facility and determining a frequency as to which said set of tasks will be performed.

23. The computer-readable medium of claim 21, wherein resolving said list of deficiencies comprises generating a set of work orders associated with said list of deficiencies to be performed by a user of said facility.

24. A computer-readable medium having computer-executable instructions for managing inspections for janitorial services, the computer-executable instructions performing the steps of:
creating an inspection order for a facility, wherein said inspection evaluates a list of services provided at said facility;
scheduling said inspection order;
dispatching said inspection order;
performing said inspection by a user of said facility, wherein inspection data is collected by said user;
creating a work order, if said inspection discovers a list of deficiencies in said list of services;
performing a follow-up inspection, if said work order is created; and
providing an inspection report based on said collected inspection data.

25. The computer-readable medium of claim 24, wherein creating an inspection order for a facility comprises the steps of:
providing job data to a storage unit for storage, wherein said job data identifies the types of services to be performed at said facility;
providing customer data to a storage unit for storage, wherein said customer data identifies a customer associated with said facility;
setting a correspondence between said job data and said customer data;
designating at least one contact to be associated with said job data; and
designating at least one user of said facility to be associated with said job data, wherein said at least one user provides services at said facility.

26. The computer-readable medium of claim 24, wherein scheduling said inspection order comprises the steps of:
creating a systematic inspection flow based on layout of said facility;
creating an inspection based on said systematic inspection flow;
scheduling a frequency of said inspection, wherein said frequency indicates how often said inspection is conducted.

27. The computer-readable medium of claim 24, wherein dispatching said inspection order comprises the steps of:
providing said inspection order to a contact associated with said facility; and
providing said inspection order to a user of said facility, wherein said user conducts said inspection order.

28. The computer-readable medium of claim 27, wherein the method further comprises:
providing a predetermined due date for said inspection order to said contact; and
providing said predetermined due date to said user.

29. The computer-readable medium of claim 24, wherein performing said inspection comprises the steps of:
conducting said inspection by said user;
providing inspection data to a storage unit for storage, wherein said inspection data is collected by said user; and
providing a report of said inspection.

30. The computer-readable medium of claim 24, wherein creating a work order comprises the steps of:
determining whether said inspection discovered a list of deficiencies in said list of services;
performing a first sequence, if said inspection discovered a list of deficiencies, said first sequence comprising the steps of:
providing a work order to a first employee of said facility, wherein said first employee completes said word order; and
providing a follow-up inspection to a second employee of said facility, wherein said second employee conducts said follow-up inspection.

31. The computer-readable medium of claim 24, wherein performing a follow-up inspection comprises the steps of:
performing said follow-up inspection by a user of said facility;
determining whether said list of deficiencies have been resolved;
providing a report indicating that said list of deficiencies have been resolved, if said list of deficiencies have been resolved.

32. The computer-readable medium of claim 24, wherein providing an inspection report comprises the steps of:
providing said inspection report to a storage unit;
providing said inspection report to a communication device for display; and
providing a statistical analysis of said inspection report to a communication device for display.
